(19) United States
(12) Patent Application Publication
(10) Pub. No.: US 2022/0397233 A1
(43) Pub. Date: Dec. 15, 2022

(54) MULTI-SURFACE STAND FOR MOUNTING DEVICES

(71) Applicant: Solar Pivot Power, Wabasha, MN (US)

(72) Inventors: Dale Hanks, Wabasha, MN (US); Uttam Singh, Austin, TX (US); Dan Moravec, Wabasha, MN (US)

(21) Appl. No.: 17/841,352

(22) Filed: Jun. 15, 2022

Related U.S. Application Data
(60) Provisional application No. 63/210,745, filed on Jun. 15, 2021.

(51) Int. Cl. F16M 11/38; F16M 11/04

(52) U.S. Cl. CPC F16M 11/38; F16M 11/041

(57) ABSTRACT

A mufti-surface stand is disclosed. The stand may comprise a main body, a rotation body connected to the main body and configured to rotate in a horizontal plane, an arm shaft connected to the rotation body, a main arm connected the arm shaft and configured to tilt in a vertical direction, a v-clamp connected to the main arm, a pan knob inserted into the main body and configured to be tightened to cause the rotation body to be prevented from rotating, a leg rotatably connected to the main body, the leg including a hollow portion configured to store therein a stake or auger having a base portion, and an integrated rotatable foot, configured to rotate between a folded position and a ground mount position.

### PRIORITY CLAIM

The present application claims the benefit of priority of U.S. Provisional Patent Application Ser. No. 63/210,745, titled “Adaptive Solar Tracking System and Portable Mechanical Solar Tracker,” filed Jun. 15, 2021, which is incorporated herein by reference.

### BACKGROUND

Portable stands are often helpful for positioning optical, photographic, scientific or solar equipment. The performance of the stand is largely dependent upon the way each leg of a stand rests on or connects to a ground surface on which the stand is placed.

### SUMMARY

One embodiment provides a multi-surface stand comprising a main body, a rotation body connected to the main body and configured to rotate in a horizontal plane, an arm shaft connected to the rotation body, a main arm connected the arm shaft and configured to tilt in a vertical direction, a v-clamp connected to the main arm, a pan knob inserted into the main body and configured to be tightened to cause the rotation body to be prevented from rotating, a leg rotatably connected to the main body, the leg including a hollow portion configured to store therein a spike or auger having a base portion, and an integrated rotatable foot, configured to rotate between a folded position and a ground mount position.

One embodiment provides a leg for a device mounting stand comprising a hollow portion configured to store therein a spike or auger having a base portion, and an integrated rotatable foot, configured to rotate between a folded position and a ground mount position, wherein the leg is configured to connect to a leg rotation bushing of the device mounting stand.

Other aspects of the disclosure will become apparent by consideration of the detailed description and accompanying drawings.

### BRIEF DESCRIPTION OF THE DRAWINGS

FIG. 1 shows a stand including an extendable foot extended into a ground mount position, suitable for placement on rugged terrain or ground soil.

FIG. 2 shows a single leg connected to a main body of the stand.

FIG. 3 shows a side sectional view of a stand including a leg configured to store a staking auger or spike.

FIG. 4 shows a top view of a mounting portion of a stand, and legs coming together to provide stability for the stand.

FIG. 5 shows a perspective view of a main body element and a rotation body element of a main connection apparatus of a stand.

FIG. 6 shows a perspective view of an arm shaft portion and a main arm portion of a connection apparatus of a stand.

FIG. 7 shows a V-clamp configured to secure equipment to a stand.

FIG. 8 shows a perspective view of a button configured to release a stand leg so that it may be moved outward from a main body of a stand while deploying the stand.

FIG. 9 shows a close-up view of an embodiment of a foot, at the bottom of a stand leg, extended into a ground mount position.

FIG. 10 shows a close-up view of the foot rotated up into the folded position.

FIG. 11 shows a stand-alone picture of a base piece with integrated stake, spike or auger.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical or hydraulic connections or couplings, whether direct or indirect.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. As used within this document, the word “or” may mean inclusive or. As a non-limiting example, if examples in this document state that “item Z may comprise element A or B,” this may be interpreted to disclose an item Z comprising only element A, an item Z comprising only element B, as well as an item Z comprising elements A and B.

Ground surface types vary widely, and it is therefore difficult to ensure a stable mechanical engagement between a stand's legs and feet and every ground surface on which the stand is placed. One solution to this problem is called ground mounting, wherein a stake or auger is driven into the ground near a stand, and then a rope or some type of tension cord connects the stand to the stake or auger. Ground mount solutions tend to require additional materials beyond the stand itself. These extra materials may get misplaced, and in some cases are aesthetically unpleasing and unpolished. Another solution of providing stability of a mounted device has been physically screwing or bolting the stand to a table or floor. However, this method is limiting as it makes moving the device difficult and may require structural changes to the table or floor on which the stand is mounted.

An integrated solution disclosed herein provides reliably sturdy connection points for stand legs on both hard surfaces and ground soil and does so without any external parts. The solution provides a non-scratch, non-slip foot for use with hard surfaces, and provides stakes configured to be stored in the legs of the stand and designed for staking the stand to the ground in rugged terrain or soil. The integrated solution disclosed herein may provide a stable platform on which to mount complementary devices, such as cameras, scientific measurement devices, solar panels, and solar trackers.

The integrated solution disclosed herein may be used to provide a wide and stable base with a device mount-point which is low to the ground. The integrated solution may be used reliably over long periods of time where the stand and mounted equipment may be unattended and hit by gusts of wind. The integrated solution disclosed herein may also be configured to provide a stable mounding base for a portable solar tracker and a solar panel. Accordingly, the integrated solution disclosed herein may be placed in an wide configuration and provide a stable anchoring system, able to withstand high-wind conditions.

The integrated solution disclosed herein may be portable and deployed by hand, without the use of power tools. The integrated solution may also be lightweight and configured to fold into a small form factor. The integrated solution may be a portable stand and may include an integrated “foot” mounted on the base of at least one of the stand legs. The integrated solution may include at least one leg and may include a plurality of legs configured to provide a stable base for mounting a device thereupon.

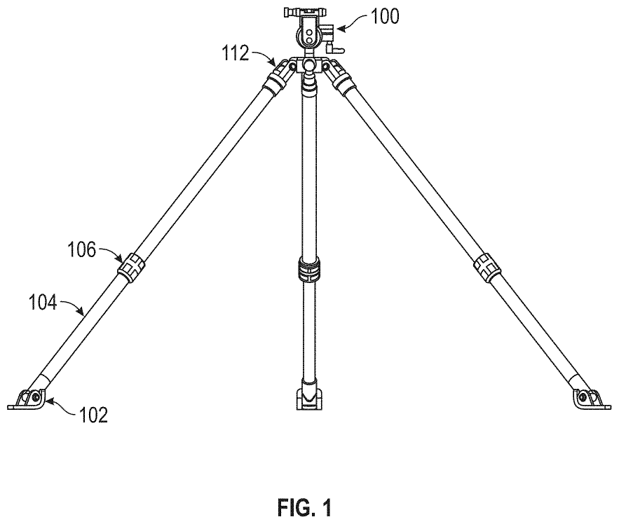

In FIG. 1, a stand 100 including an integrated foot 102 connected to a leg 104 is shown. The integrated foot 102 may be rotatable between a folded position and ground mount position and held in place by a disc spring 103, In the embodiment shown, the integrated foot 102 is extended into a ground mount position, making the position of the foot suitable for placement on rugged terrain or ground soil. A twist lock 106 configured to enable the stand legs 104 to transition between the folded position fully retracted) and a plurality of leg lengths (e.g., fully extended). The twist lock 106 may be twisted in a first direction to disengage a length locking mechanism and allow the leg to be extended or retracted to a desired length. The twist lock 106 may then be twisted in a second direction to reengage the length locking mechanism to secure the leg at the selected length. A leg rotation bushing 108 may include a rotational locking mechanism (e.g., a pawl or ratchet system). When pressed, the leg button may release the rotational locking mechanism (not shown), enabling the leg 104 to be rotated into a plurality of positions in order to provide a wide and stable base fora mounted device (not shown).

FIG. 2 shows a single leg 104 connected to the main body 110 of the stand 100. In the embodiment shown, the leg button 112, when pressed down, is configured to release the rotational locking mechanism, thereby releasing the leg 104 from a rotationally locked configuration so that the leg 104 may be rotated outward and locked into a plurality of positions. As the leg 104 is rotated outward, it may provide a progressively wider base and lower the main body of the stand 100 closer to the ground, A pan knob 114 inserted into the main body 110 may be used to release and tighten a rotation body 116 of the stand 100, The rotation body 116 may be configured to enable a mounted device (e.g., a solar panel mounted to the stand 100) to be rotated into a suitable position along the horizontal plane (e.g., panned). A main arm 118 inserts into an arm shaft 120 and provides a connection point for a V-clamp 132 configured to secure a mounted device to the stand 100. A lever knob 122 connected to the main arm 118 may be configured to release and tighten the main arm 118 so that it may be rotated into a level position parallel to the ground.

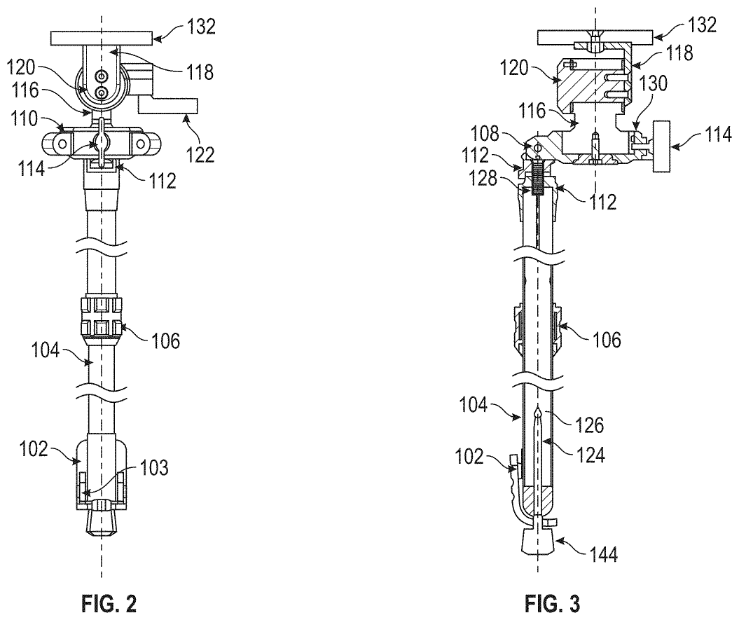

FIG. 3 shows a side view of many of the same elements as FIG. 2 from a sectional view, An integrated stake, spike or auger 124 is shown stored in a hollow portion 126 inside the leg 104, configured to store the spike or auger 124. A spring 128 may work in conjunction with the leg button 112 to rotate the leg 104 outward from the main body assembly. A leg rotation bushing 108, connected to the main body 110, may be used to attach the leg 104 to the main body. A pan cam 130, connected to the pan knob 114, may be configured to work in conjunction with the pan knob 114 to tighten and release the rotation body 116.

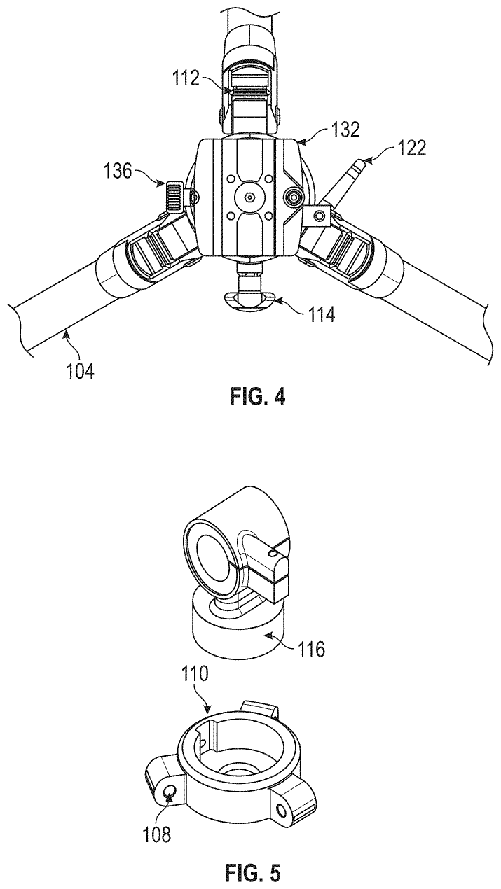

FIG. 4 shows a top view of the stand 100, and illustrates how the legs 104 may form a stable base for the main body 110 and the V-clamp 132. In the embodiment shown the V-clamp 132 has a center hole used to attach it to the main arm 118. The V-clamp 132 may also include U-shaped slots and holes surrounding the center hole of the V-clamp 132 for aligning a mounted device on the V-clamp 132. In some embodiments a bubble level, which may aid the user in leveling a mounted device, is disposed on the main body 110 or rotation body 116.

FIG. 5 shows a perspective view of the main body 110 and rotation body 116. These parts may form the basis for pan and tilt capabilities of the stand 100, whereby a mounted device may be repositioned along the horizontal and vertical axes. The leg rotation bushing 108 may provide a connection point for the legs 104.

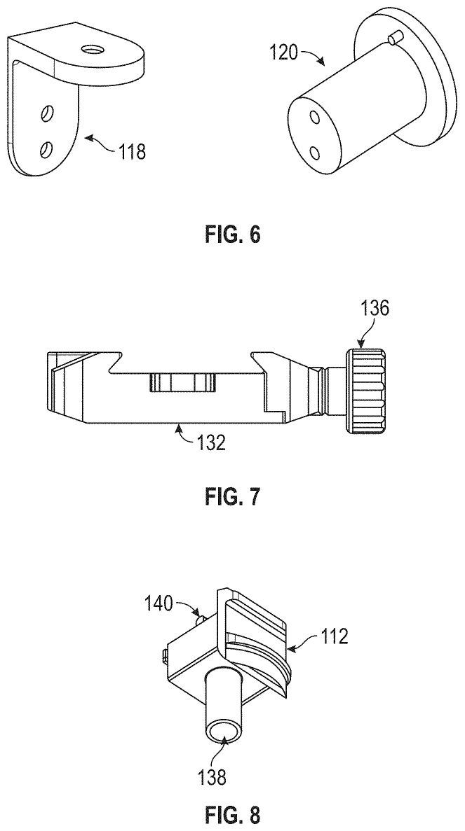

FIG. 6 shows a perspective view of the arm shaft 120 and main arm 118 portions of the stand. These parts may provide a means by which the V-clamp 132 is attached to the rotation body 116 and tilted into a desirable position.

FIG. 7 shows a V-clamp 132 configured to be used as a vise-like component to secure a mounted device to the stand 100. The V-clamp 132 connects to the main arm 118 with a fastener 134 such as a bolt, allen screw or similar piece of connection hardware. Once the fastener 124 is inserted into the V-clamp 132, a V-clamp knob 136 is tightened to secure the device.

FIG. 8 shows a perspective view of the leg button 112 configured to release the stand leg 104 so that it may be moved outward from the main body 110 of the stand 100 in order to form a stable, wide base. The leg button insert 138 may be positioned inside a spring 128 on the interior of the leg 104. A leg button stop 140 is used to lock the leg into a plurality of positions using notches on the main body 110.

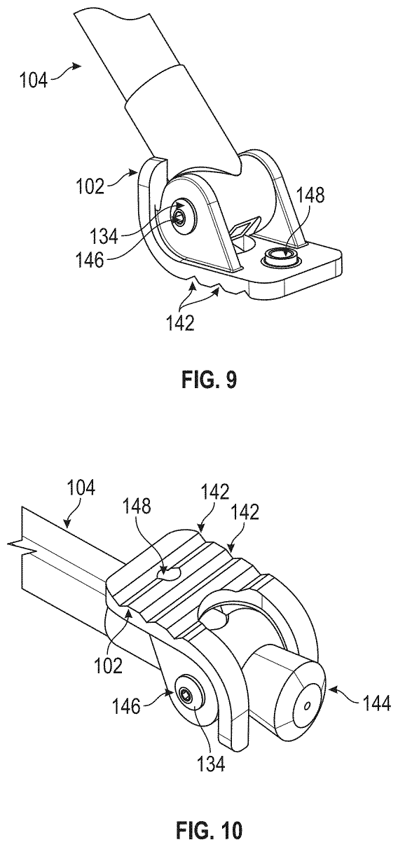

FIG. 9 shows a close-up view of an embodiment of the foot 102, extended into a ground mount position. The foot 102 may be rotatably connected to the leg 104 using a swivel point 146 such as a bolt or set screw. As shown in FIG. 9, the leg 104 is supported by the foot 102. The foot 102 may include an opening 148 in the interior of the foot 102, configured to enable a stake, spike, auger 124 or similar anchoring mechanism to be inserted into the ground, thus securing the stand. The integrated foot 102 may also comprise a series of V-grooves 142 on the bottom of the foot, so as to increase the surface area coverage of the foot 102.

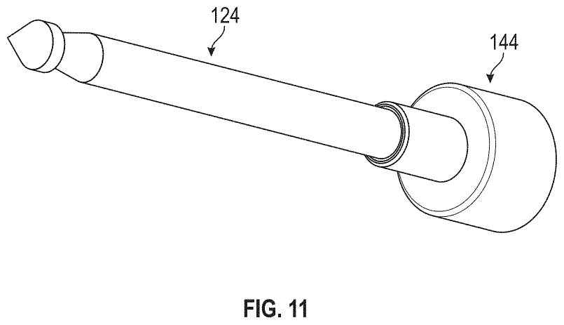

FIG. 10 shows a close-up view of the foot 102, rotated on a swivel point 146, such as a bolt or set screw, up into the folded position. An integrated stake, spike or auger 124 may be inserted into the base of the leg 104. The base piece 144 of the stake or auger 124 may be made from hard rubber, plastic or similar non-scratch, non-slip material, suitable for placement on a hard surface. In the embodiment shown, the interior of the foot 102 contains an opening configured to allow the auger or spike 124 to be stored therein.

FIG. 11 shows a base piece 144 with an integrated stake, spike or auger 124, In the stored position, the integrated stake 124 is inserted into the base of the leg 104, and attached by screwing the base piece 144 into the leg 104. Clips, snaps, friction fit or any other suitable attachment mechanism may be used to secure the base piece 144 into the leg 104. The base piece 144 may be constructed from rubber, hard plastic or similar non-scratch, non-slip material, suitable for placement on a hard surface. In the embodiment shown, the integrated stake, spike or auger 124 has been removed from the leg 104 and may be used to anchor the foot 102, which would have been extended into the ground-mount position, by inserting stake or auger 124 into the opening 148 in the interior of the foot 102 and pressing, hammering or screwing it into the ground.

Although certain aspects have been described in detail with reference to certain preferred embodiments, variations and modifications exist within the scope and spirit of one or more independent aspects as described.

What is claimed is:

1. A multi-surface stand comprising:
a main body;
a rotation body connected to the main body and configured to rotate in a horizontal plane;
an arm shaft connected to the rotation body;
a main arm connected the arm shaft and configured to tilt in a vertical direction;
a v-clamp connected to the main arm;
a pan knob inserted into the main body and configured to be tightened to cause the rotation body to be prevented from rotating;
a leg rotatably connected to the main body, the leg including a hollow portion configured to store therein a stake or auger having a base portion; and,
an integrated rotatable foot, configured to rotate between a folded position and a ground mount position.

2. The multi-surface stand of claim 2, wherein the integrated rotatable foot includes a cutout configured to accommodate the stake or auger being inserted therethrough in the folded position for storage in the hollow portion.

3. The multi-surface stand of claim 2, wherein the integrated rotatable foot includes V-grooves on a bottom of the rotatable foot.

4. The multi-surface stand of claim 2, wherein the integrated rotatable foot includes an opening configured to accommodate the stake or auger being inserted therethrough in the ground mount position.

5. The multi-surface stand of claim 1, further comprising a leg rotation bushing connected to the main body and configured to provide a connection point for the leg; and,
wherein the leg is rotatably connected to the main body in that the leg is configured to connect to the leg rotation bushing.

6. The multi-surface stand of claim 6, wherein the leg rotation bushing includes a rotational locking mechanism configured to enter a locked configuration that prevents the leg from rotating.

7. The multi-surface stand of claim 7, wherein the leg includes a leg button configured to release the rotational locking mechanism from the locked configuration.

8. The multi-surface stand of claim 1, the leg further comprising a twist lock configured to be twisted in a first direction to disengage a length locking mechanism and allow the leg to be extended or retracted to a desired length, and to be twisted in a second direction to reengage the length locking mechanism to secure the leg at a selected length.

9. The multi-surface stand of claim 1, wherein the leg is one of three legs.

10. A leg for a device mounting stand comprising:
a hollow portion configured to store therein a stake or auger having a base portion; and,
an integrated rotatable foot, configured to rotate between a folded position and a ground mount position,
wherein the leg is configured to connect to a leg rotation bushing of the device mounting stand.

11. The leg of claim 10, wherein the integrated rotatable foot includes a cutout configured to accommodate the stake or auger being inserted therethrough in the folded position for storage in the hollow portion.

12. The leg of claim 11, wherein the integrated rotatable foot includes V-grooves on a bottom the rotatable foot.

13. The leg of claim 11, wherein the integrated rotatable foot includes an opening configured to accommodate the stake or auger being inserted therethrough in the ground mount position.

14. The leg of claim 10, wherein the leg includes a leg button configured to release a rotational locking mechanism of the leg rotation bushing.

15. The leg of claim 10, the leg further comprising a twist lock configured to be twisted in a first direction to disengage a length locking mechanism and allow the leg to be extended or retracted to a desired length, and to be twisted in a second direction to reengage the length locking mechanism to secure the leg at a selected length.
